(19) United States
(12) Patent Application Publication
(10) Pub. No.: US 2026/0132808 A1
(43) Pub. Date: May 14, 2026

(54) CONNECTION MODULES AND MODULAR ASSEMBLED FURNITURE

(71) Applicant: HANGZHOU ZHIHUIJIA EDGE INTELLIGENT MANUFACTURING TECHNOLOGY CO., LTD., Hangzhou (CN)

(72) Inventors: Chao CHEN, Hangzhou (CN); Yonghui PENG, Hangzhou (CN)

(73) Assignee: HANGZHOU ZHIHUIJIA EDGE INTELLIGENT MANUFACTURING TECHNOLOGY CO., LTD., Hangzhou (CN)

(21) Appl. No.: 19/445,443

(22) Filed: Jan. 9, 2026

Related U.S. Application Data
(63) Continuation of application No. PCT/CN2024/111810, filed on Aug. 13, 2024.

(30) Foreign Application Priority Data
Jul. 10, 2023 (CN) 202310842744.7

(51) Int. Cl. F16B 12/14; F16H 37/16

(52) U.S. Cl. CPC F16B 12/14; F16H 37/16

(57) ABSTRACT

A connection module and modular assembled furniture are provided. The connection module includes a housing, a direction-changing device, an advancing device, and an adapter module. The housing is provided with a first hole and a second hole. A nut groove is provided near an opening of the first hole. The direction-changing device includes an input member and an output member disposed in the second hole and the first hole, respectively. The advancing device includes a bolt and a nut. The nut is disposed in the nut groove. The bolt includes a threaded portion and a smooth portion. The smooth portion is axially slidably connected to the output member and is provided with a circlip groove. A circlip is disposed in the circlip groove. A spring is disposed between the circlip and the nut. The adapter module is threadedly connected to the bolt after the bolt is advanced.

### CROSS-REFERENCE TO RELATED APPLICATIONS

This application is a Continuation of International Application No. PCT/CN2024/111810, filed on Aug. 13, 2024, which claims priority to Chinese Patent Application No. 202310842744.7, filed on Jul. 10, 2023, the entire contents of each of which are hereby incorporated by reference.

### TECHNICAL FIELD

The present disclosure relates to a field of modular assembled furniture, and in particular to connection modules and modular assembled furniture.

### BACKGROUND

Currently, most existing frame boxes, brackets, or other support structures achieve the connection between an adapter and a connecting pipe by means of insertion, welding, adhesive bonding, or threaded connection. Threaded connection is favored for its firm connection and convenience in installation and disassembly. The threaded connections used in most existing frame boxes, brackets, or other support structures mostly involve directly tapping or threading a connecting end of the connecting pipe and correspondingly threading or tapping a connecting end of the adapter. During an installation process, the connection between the connecting pipe and the adapter is achieved by rotating the entire connecting pipe or the adapter along its axis. However, with this current connection manner, since it requires rotating the entire connecting pipe or the adapter along its axis, the installation is relatively laborious. This is particularly time-consuming and labor-intensive when connecting pipes with larger diameters, greater lengths, and heavier weights. For brackets with complex structures, it is often necessary to assemble multiple bracket components together, and rotating the entire bracket structure along the axis of the connecting pipe is clearly unsuitable.

Therefore, existing technologies have the problems of time-consuming and laborious installation, and it is difficult to apply to large-sized, heavy-mass connecting pipes and structurally complex brackets.

### SUMMARY

To overcome the deficiencies in the existing technologies, one or more embodiments of the present disclosure provide a connection module. The connection module includes a housing, a direction-changing device, an advancing device, and an adapter module. The housing is provided with a first hole and a second hole. The first hole is perpendicular to and communicates with the second hole. A nut groove is provided near an opening of the first hole. The direction-changing device includes an input member and an output member. The input member and the output member are respectively disposed in the second hole and the first hole. The input member is connected to the output member. Rotation of the input member in a horizontal direction drives the output member to rotate in a vertical direction. The advancing device is disposed in the first hole. The advancing device includes a bolt and a nut. The nut is disposed in the nut groove. The bolt includes a threaded portion and a smooth portion. The threaded portion is threadedly connected to the nut. The smooth portion is radially fixed and axially slidably connected to the output member. The smooth portion is provided with a circlip groove, a circlip is disposed in the circlip groove. A spring is disposed between the circlip and the nut, and the spring is disposed on the bolt. The adapter module is disposed at an exterior of the housing and includes a thread matching the bolt. The adapter module is threadedly connected to the bolt after the bolt is advanced. An end surface of the threaded portion of the bolt is provided with a safety groove. The connection module further includes a position limiting device mounted on the housing. The position limiting device includes a limiting part and a limiting foot. The limiting part is connected to the limiting foot. The limiting part is provided with an adjustment opening. The adjustment opening faces an input end of the input member.

The connection module is disposed in a connecting pipe. By configuring an upper surface of the limiting part as a horizontal structure, the connection module is suitable for a square connecting pipe. By configuring the limiting part with an upper surface having a certain curvature, the connection module is suitable for a circular connecting pipe.

In some embodiments, the input member is a driving bevel gear. An input end of the driving bevel gear is provided with a positioning groove. The output member is a driven bevel gear. An output end of the driven bevel gear is provided with a connecting portion. The connecting portion is connected to one end of the smooth portion of the bolt. The driven bevel gear meshes with the driving bevel gear.

In some embodiments, the input member and the output member may also adopt other steering transmission shafts that can achieve 90-degree direction change.

In some embodiments, the one end of the smooth portion of the bolt is provided with a connector. The connector is connected to the connecting portion.

In some embodiments, the connector has a shape of a regular hexagonal prism. The connecting portion has a cylindrical shape. The connecting portion is provided with a regular hexagonal blind hole at an end away from the driven bevel gear. The connector is arranged in the regular hexagonal blind hole and slides axially along the regular hexagonal blind hole. Alternatively, the connector has a shape of a regular quadrangular prism. The connecting portion has a cylindrical shape. The connecting portion is provided with a square blind hole at an end away from the driven bevel gear. The connector is arranged in the square blind hole and slides axially along the square blind hole. Alternatively, the connector has a cylindrical shape. An end surface of the connector is provided with a regular hexagonal blind hole. The connecting portion has a shape of a regular hexagonal prism. The connecting portion is arranged in the regular hexagonal blind hole and slides axially along the regular hexagonal blind hole. Alternatively, the connector has a cylindrical shape. The end surface of the connector is provided with a square blind hole. The connecting portion has a shape of a regular quadrangular prism. The connecting portion is arranged in the square blind hole and slides axially along the square blind hole.

In some embodiments, the housing is further provided with a limiting hole. The limiting hole is configured to receive the limiting foot. A rubber ring groove is provided in the limiting hole. A rubber ring is disposed in the rubber ring groove. After the connection module is placed into the connecting pipe and the position limiting device is inserted into the limiting hole of the housing, the rubber ring engages with the limiting foot of the position limiting device via an interference fit, firmly locking the position limiting device. At this time, the limiting part of the position limiting device protrudes above the connection module and precisely engages with an opening of the connecting pipe, thereby, limiting and fixing the connection module and the connecting pipe.

In some embodiments, the housing includes a first shell and a second shell that are assembled together, and a cross-section of the housing is of an elliptical shape. Corresponding to the housing, an internal cross-section of the connecting pipe is also an elliptical shape. When the connection module is installed into the connecting pipe, it is more convenient to align the second hole of the connection module with the opening on the connecting pipe without a need to rotate the connection module for positional alignment.

In some embodiments, one end of the smooth portion of the bolt is provided with a flange. A limiting protrusion is provided in the first hole near the output member. The limiting protrusion is configured to abut against the flange of the bolt. By providing the limiting protrusion to abut against the flange of the bolt, an advancement distance of the bolt is limited, which can prevent the connector of the bolt from disengaging from the connecting portion of the output member, thereby avoiding failure of the advancing device.

In some embodiments, the adapter module includes a multi-way connector and a protective shell. The multi-way connector is provided with an internal thread adapted to the bolt. The multi-way connector is disposed in the protective shell. A shape of the protective shell conforms to the adapter module. The adapter module is used for threadedly connecting to the bolt. The adapter module replaces the nut when the threaded portion of the bolt is disengaged from the nut, allowing the bolt to continue advancing.

In some embodiments, the safety groove is a hexagonal blind hole or a square blind hole. A correspondingly shaped screwdriver is placed in the safety groove. Rotating the screwdriver causes the bolt to retract from the adapter module, thereby disassembling the connection module.

One or more embodiments of the present disclosure further provide an article of modular assembled furniture including the connection module as described above.

To make the above and other objectives, features, and advantages of the embodiments of the present disclosure more comprehensible, the following describes preferred embodiments in detail with reference to the accompanying drawings.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting schematic embodiments, in which like reference numerals represent similar structures throughout the several views of the drawings, and wherein:

FIG. 1 is a schematic cross-sectional structural diagram of a connection module according to some embodiments of the present disclosure.

FIG. 2 is a schematic diagram of a front view of a direction-changing device according to some embodiments of the present disclosure.

FIG. 3 is a schematic diagram of a top view of the direction-changing device according to some embodiments of the present disclosure.

FIG. 4 is a schematic diagram of a perspective view of an advancing device according to some embodiments of the present disclosure.

FIG. 5 is a schematic cross-sectional structural diagram of a housing with a limiting protrusion according to some embodiments of the present disclosure.

FIG. 6 is a schematic diagram of a perspective view of a circlip according to some embodiments of the present disclosure.

FIG. 7 is a schematic diagram of a perspective view of a position limiting device according to some embodiments of the present disclosure.

FIG. 8 is a schematic diagram of a top view of a rubber ring according to some embodiments of the present disclosure.

FIG. 9 is a schematic diagram of a top view of a housing according to some embodiments of the present disclosure.

FIG. 10 is a schematic diagram of a perspective view of an adapter module according to some embodiments of the present disclosure.

Reference numerals in the drawings are:
1: direction-changing device; 11: input member; 111: positioning groove; 12: output member; 121: connecting portion; 2: advancing device; 21: bolt; 211: circlip groove; 212: safety groove; 22: nut; 23: connector; 24: flange; 3: housing; 31: first hole; 32: second hole; 33: nut groove; 34: limiting hole; 35: rubber ring groove; 36: first shell; 37: second shell; 38: limiting protrusion; 4: adapter module; 41: multi-way connector; 42: protective shell; 5: circlip; 6: spring; 7: position limiting device; 71: limiting part; 711: adjustment opening; 72: limiting foot; 8: rubber ring.

### DETAILED DESCRIPTION

It should be noted that the terms “system”, “unit”, “module”, and/or “block” used herein are one method to distinguish different components, elements, parts, sections or assemblies of different levels in ascending order. However, the terms may be displaced by another expression if they achieve the same purpose.

As shown in the present disclosure and the claims, unless the context clearly indicates an exception, the words “a”, “an”, “one”, and/or “the” are not limited to singular forms and may also include plural forms. Generally, the terms “include” and “comprise” only indicate inclusion of explicitly identified elements, and these elements do not constitute an exclusive list. The device may also include other elements.

To facilitate understanding by those skilled in the art, the present disclosure is described in further detail below in conjunction with specific embodiments.

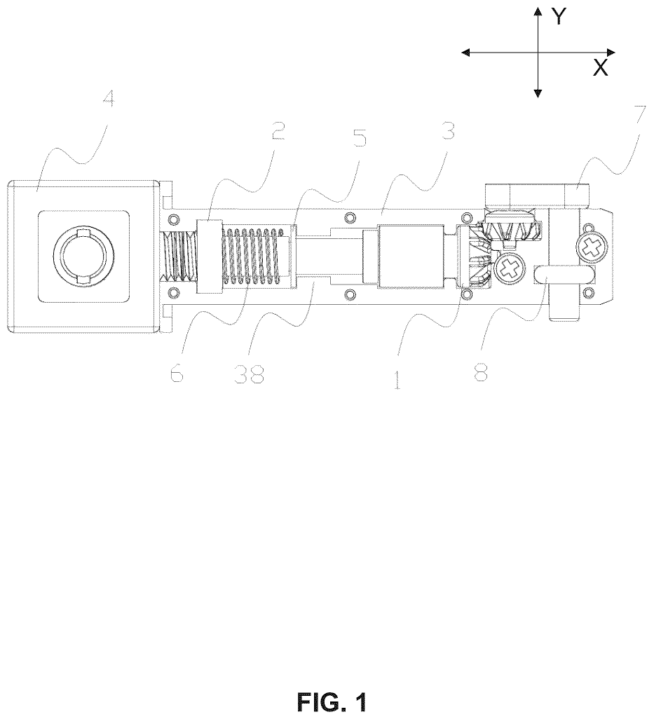

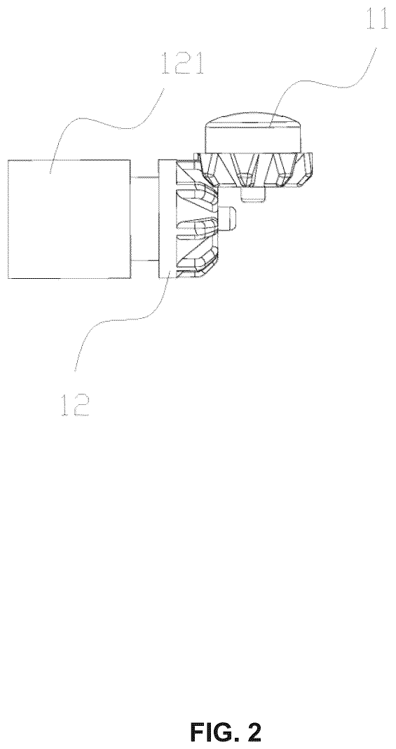

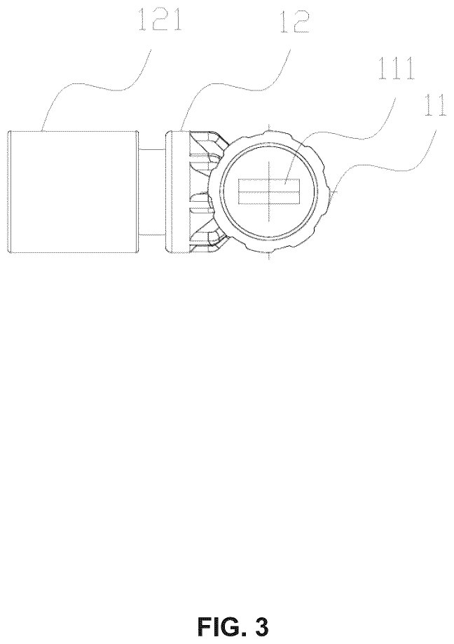

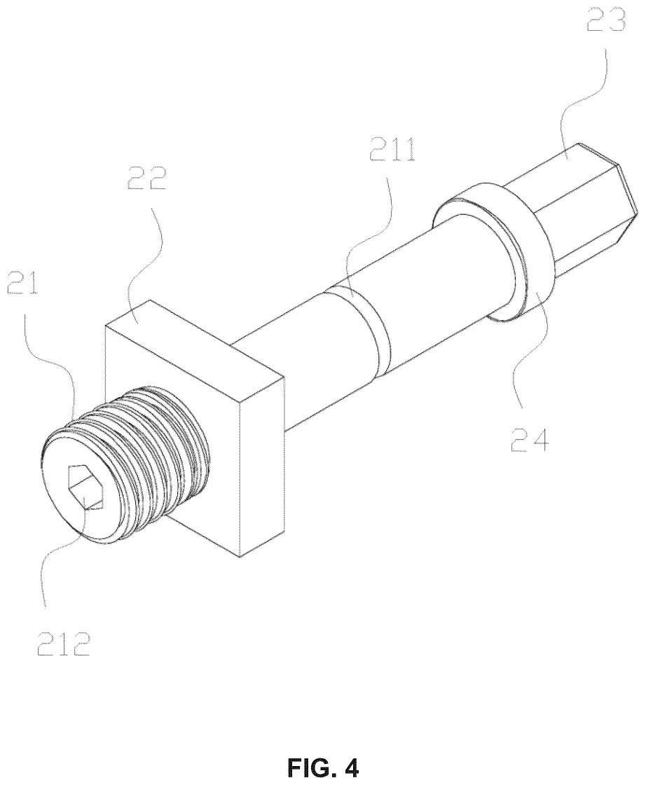

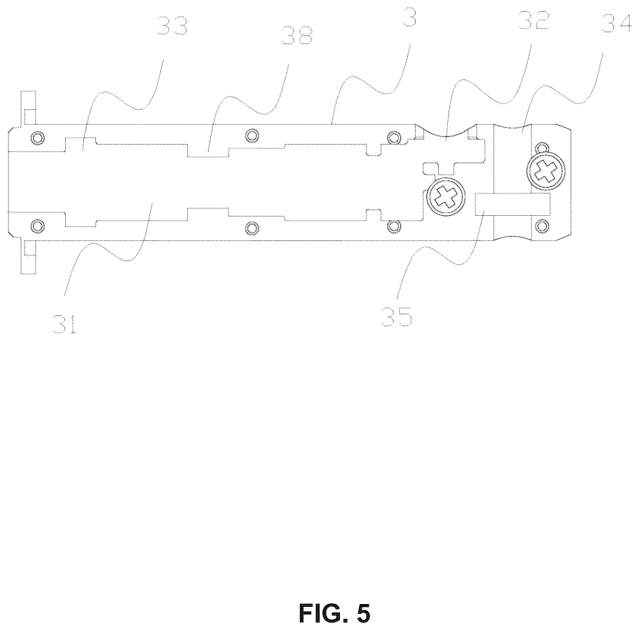

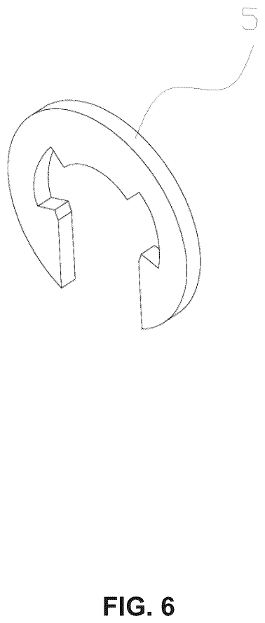

FIG. 1 is a schematic cross-sectional structural diagram of a connection module according to some embodiments of the present disclosure. FIG. 2 is a schematic diagram of a schematic diagram of a front view of a direction-changing device according to some embodiments of the present disclosure. FIG. 3 is a schematic diagram of a top view of the direction-changing device according to some embodiments of the present disclosure. FIG. 4 is a schematic diagram of a perspective view of an advancing device according to some embodiments of the present disclosure. FIG. 5 is a schematic cross-sectional structural diagram of a housing with a limiting protrusion according to some embodiments of the present disclosure. FIG. 6 is a schematic diagram of a perspective view of a circlip according to some embodiments of the present disclosure.

Referring to FIGS. 1-6, the connection module provided in an embodiment of the present disclosure includes a housing 3, a direction-changing device 1, an advancing device 2, and an adapter module 4. The housing 3 is provided with a first hole 31 and a second hole 32. The first hole 31 is perpendicular to and communicates with the second hole 32. A nut groove 33 is provided near an opening of the first hole 31. The direction-changing device 1 includes an input member 11 and an output member 12. The input member 11 and the output member 12 are respectively disposed in the second hole 32 and the first hole 31. The input member 11 is connected to the output member 12. Rotation of the input member 11 in a horizontal direction drives the output member 12 to rotate in a vertical direction. The advancing device 2 is disposed in the first hole 31. The advancing device 2 includes a bolt 21 and a nut 22. The nut 22 is disposed in the nut groove 33. The bolt 21 includes a threaded portion and a smooth portion. One end of the threaded portion is threadedly connected to the nut 22. One end of the smooth portion is radially fixed and axially slidably connected to the output member 12. The smooth portion is provided with a circlip groove 211, and a circlip 5 is disposed in the circlip groove 211. A spring 6 is disposed between the circlip 5 and the nut 22. The spring 6 is disposed on the bolt 21. The adapter module 4 is disposed at an exterior of the housing 3. The adapter module 4 includes a thread matching the bolt 21. The adapter module 4 is threadedly connected to the bolt 21 after the bolt 21 is advanced. In the embodiments of the present disclosure, “horizontal” refers to a direction indicated by X in FIG. 1, and “vertical” refers to a direction indicated by Y in FIG. 1.

The housing 3 refers to a shell configured to protect an internal structure of the connection module. The first hole 31 is configured to accommodate the advancing device 2 and the output member 12. The second hole 32 is configured to accommodate the input member 11.

The direction-changing device 1 refers to a device configured to change a movement direction of a driven member (e.g., the output member 12) while an input direction remains unchanged. The input member 11 is configured to receive a force (e.g., a horizontal rotational force) input from outside the housing 3 and transmit the force to the output member 12. The output member 12 is configured to change a direction of the force from the input member 11 and output the force to the advancing device 2.

The advancing device 2 refers to a device configured to advance the bolt 21 to connect to the adapter module 4. The bolt 21 cooperates with the nut 22 to convert vertical rotation into horizontal displacement to achieve advancement toward the adapter module 4.

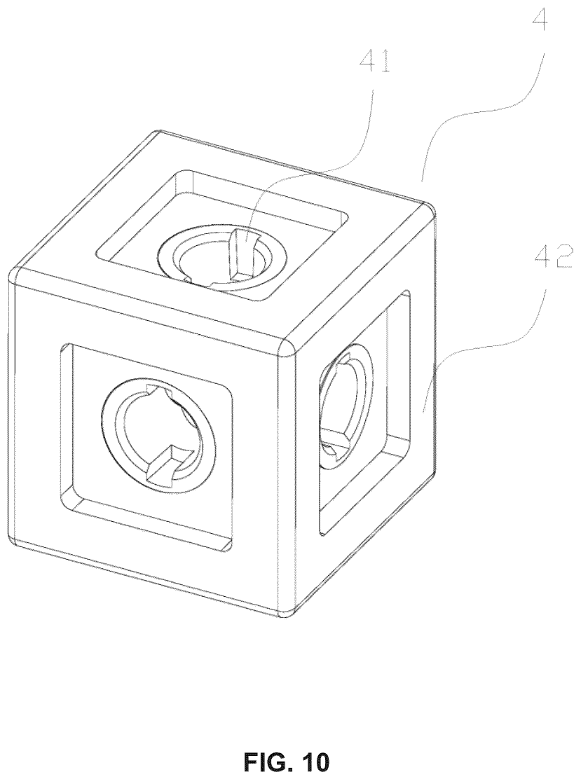

The adapter module 4 refers to a module configured to connect to other connection modules. For example, the adapter module 4 may be a cube or a cuboid, and opposite faces may have identical configurations to facilitate connection to other connection modules. More descriptions regarding the adapter module 4 may be found in FIG. 10 and related descriptions thereof.

In some embodiments, an end surface of the threaded portion of the bolt 21 is provided with a safety groove 212. The safety groove 212 refers to a groove body configured to facilitate direct control of rotation of the bolt 21 by a screwdriver when the advancing device 2 fails.

In an implementation of the embodiment, the connection module is disposed in a connecting pipe. The connecting pipe refers to a tubular member sleeved over an exterior of the housing 3 when the connection module is connected. The circlip 5 is configured to compress the spring 6 during an advancement process. After being compressed, the spring 6 generates an elastic deformation and then tightly fits the adapter module 4 to the connecting pipe through an elastic force.

In an implementation of the embodiment, as shown in FIG. 3, the input member 11 is a driving bevel gear. An input end of the driving bevel gear is provided with a positioning groove 111. The output member 12 is a driven bevel gear. An output end of the driven bevel gear is provided with a connecting portion 121. The connecting portion 121 is connected to one end of the smooth portion of the bolt 21. The driven bevel gear meshes with the driving bevel gear.

In an implementation of the embodiment, the positioning groove 111 is a straight slot or a cross-shaped slot.

In an implementation of the embodiment, the input member 11 and the output member 12 may also be other types of steering transmission shafts capable of achieving 90-degree direction change.

In some embodiments of the present disclosure, by configuring the input member 11 as the driving bevel gear provided with the positioning groove 111, and configuring the output member 12 as the driven bevel gear meshing with the driving bevel gear, and connecting the bolt 21 through the connecting portion 121, a tool such as a screwdriver can be used to drive the input member 11 to rotate horizontally. The horizontal rotation of the input member 11 is converted into vertical rotation of the output member 12, thereby driving the bolt 21 to rotate to achieve advancement.

In an implementation of the embodiment, as shown in FIGS. 3-4, one end of the smooth portion of the bolt 21 is provided with a connector 23, which is connected to the connecting portion 121. After the connector 23 is connected to the connecting portion 121, the connector 23 and the connecting portion 121 are coaxial and can cooperate to transmit rotation along an axial direction.

In an implementation of the embodiment, the connector 23 has a shape of a regular hexagonal prism. The connecting portion 121 has a cylindrical shape. The connecting portion 121 is provided with a regular hexagonal blind hole at an end away from the driven bevel gear. The connector 23 is disposed in the regular hexagonal blind hole and slides axially along the regular hexagonal blind hole. Alternatively, the connector 23 has a shape of a regular quadrangular prism. The connecting portion 121 has a cylindrical shape. The connecting portion 121 is provided with a square blind hole at an end away from the driven bevel gear. The connector 23 is disposed in the square blind hole and slides axially along the square blind hole.

In an implementation of the embodiment, the connector 23 has a cylindrical shape. An end surface of the connector 23 is provided with a regular hexagonal blind hole. The connecting portion 121 has a shape of a regular hexagonal prism. The connecting portion 121 is disposed in the regular hexagonal blind hole and slides axially along the regular hexagonal blind hole. Alternatively, the connector 23 has a cylindrical shape. The end surface of the connector 23 is provided with a square blind hole. The connecting portion 121 has a shape of a regular quadrangular prism. The connecting portion 121 is disposed in the square blind hole and slides axially along the square blind hole.

In some embodiments of the present disclosure, by connecting and cooperating the connector 23 with the connecting portion 121, rotation of the output member 12 can be stably transmitted through the connecting portion 121 to the connector 23, thereby driving the bolt 21 to rotate vertically. Finally, under the action of the nut 22, the rotation is converted into a force for advancing the bolt 21 horizontally.

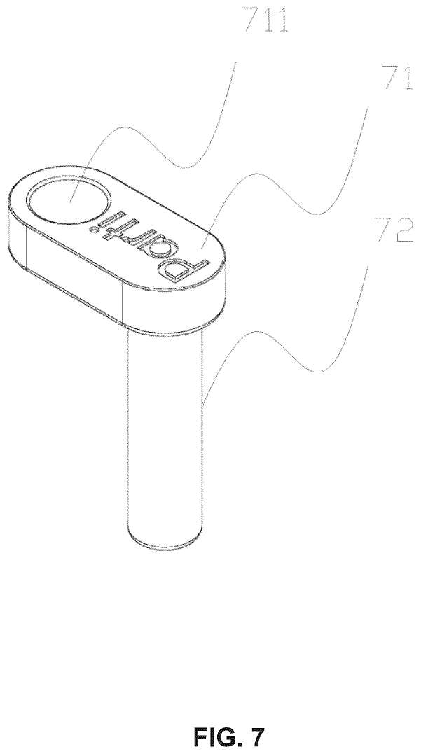

FIG. 7 is a schematic diagram of a perspective view of a position limiting device according to some embodiments of the present disclosure.

In an implementation of the embodiment, as shown in FIGS. 1 and 7, the connection module further includes a position limiting device 7 mounted on the housing 3. The position limiting device 7 includes a limiting part 71 and a limiting foot 72. The limiting part 71 is connected to the limiting foot 72. The limiting part 71 is provided with an adjustment opening 711. The adjustment opening 711 faces an input end of the input member 11.

The position limiting device 7 refers to a device for limiting and fixing the connecting pipe and the connection module. The limiting part 71 and the limiting foot 72 refer to components configured to cooperate to restrict displacement between the connecting pipe and the connection module. For example, a distance from an upper surface of the limiting part 71 to an end surface of the limiting foot 72 away from the limiting part 71 may match an internal dimension of the connecting pipe, so that radial displacement of the housing 3 installed in the connecting pipe along the connecting pipe can be restricted. The adjustment opening 711 refers to an opening for allowing a screwdriver to enter the connection module to rotate the input member 11.

In an implementation of the embodiment, the limiting part 71 is configured as a structure with a horizontal upper surface.

In an implementation of the embodiment, the limiting part 71 is configured as a structure with an upper surface having a certain curvature.

When the upper surface of the limiting part 71 is configured as a horizontal structure, the connection module may be used for a square connecting pipe. When the limiting part 71 is configured as a structure with an upper surface having a certain curvature, the connection module may be used for a circular connecting pipe.

In some embodiments of the present disclosure, by providing the connection module including the housing 3, the direction-changing device 1, the advancing device 2, the adapter module 4, and the position limiting device 7, installation of the connection module can be achieved without rotating the entire connecting pipe or the adapter module 4. The connection module is convenient to assemble and disassemble, thereby facilitating installation and disassembly while ensuring structural stability after installation.

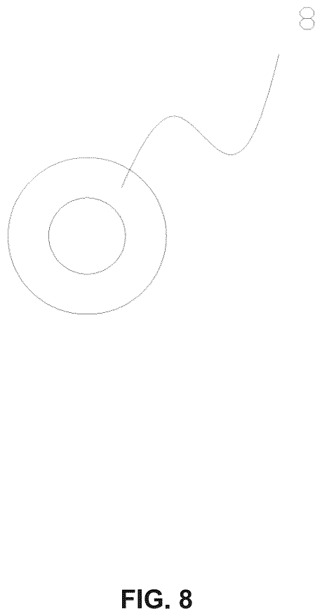

FIG. 8 is a schematic diagram of a top view of a rubber ring according to some embodiments of the present disclosure.

In some embodiments, as shown in FIGS. 5 and 8, the housing 3 is further provided with a limiting hole 34 for receive the limiting foot 72. A rubber ring groove 35 is provided in the limiting hole 34. A rubber ring 8 is disposed in the rubber ring groove 35. The rubber ring 8 is configured to increase friction to restrict movement of the limiting foot 72, thereby avoiding unnecessary displacement of the limiting foot 72. By providing the limiting hole 34 provided with the rubber ring groove 35 and the rubber ring 8, the position limiting device 7 can be fixed more stably, thereby achieving a better limiting effect.

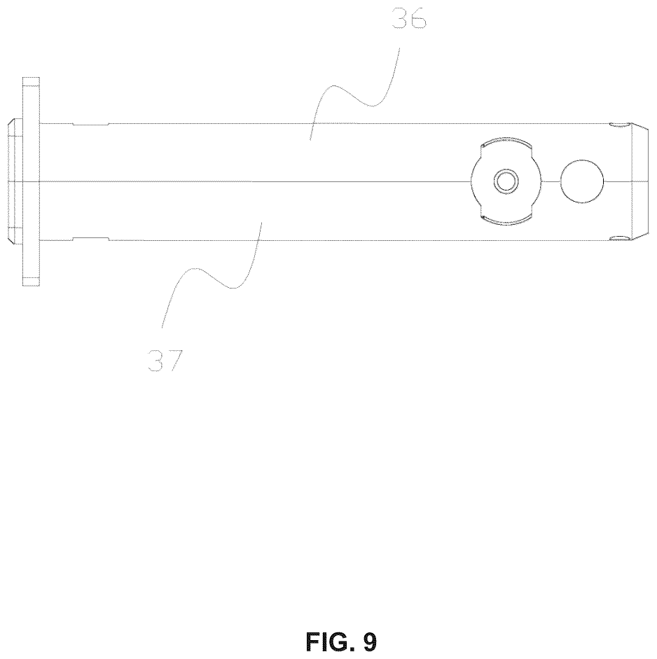

FIG. 9 is a schematic diagram of a top view of a housing according to some embodiments of the present disclosure.

In an implementation of the present embodiment, as shown in FIG. 9, the housing 3 includes a first shell 36 and a second shell 37 that are assembled together. A cross-section of the housing 3 is of an elliptical shape. The first shell 36 refers to a housing part on a side of the housing 3. The second shell 37 refers to a housing part on a side symmetrical to the first shell 36. The cross-section mentioned in the embodiments of the present disclosure refers to a section after being cut along a direction indicated by Y in FIG. 1.

In some embodiments, corresponding to the cross-section of the housing 3, a shape of an internal cross-section of the connecting pipe may also be configured as an elliptical shape. This configuration facilitates alignment of the second hole 32 of the connection module with an opening on the connecting pipe when the connection module is placed into the connecting pipe, without the need to rotate the connection module for positional alignment.

In some embodiments of the present disclosure, by configuring the housing 3 to be assembled from the first shell 36 and the second shell 37 and by setting the cross-section of the housing 3 to an elliptical shape, the housing 3 becomes easy to produce, assemble, or disassemble, thereby improving production efficiency. In other embodiments, the cross-section of the housing 3 and the shape of the internal cross-section of the connecting pipe may also be a rectangle, a hexagon, or the like, and may be designed according to actual requirements.

In an implementation of the present embodiment, as shown in FIGS. 1 and 4, one end of the smooth portion of the bolt 21 is provided with a flange 24. A limiting protrusion 38 is provided in the first hole 31 near the output member 12. The limiting protrusion 38 is configured to abut against the flange 24 of the bolt 21. By providing the flange 24 and the limiting protrusion 38, the flange 24 of the bolt 21 can be abutted to limit an advancement distance of the bolt 21, thereby preventing the connector 23 of the bolt 21 from disengaging from the connecting portion 121 of the output member 12, which may cause failure of the advancing device 2.

In an implementation of the present embodiment, as shown in FIG. 4, the safety groove 212 is a hexagonal blind hole or a square blind hole. By configuring the safety groove 212 as a hexagonal blind hole or a square blind hole, a technician can control a movement direction of the bolt 21 from the end of the threaded portion of the bolt 21, thereby avoiding difficulty in disassembling the connection module when the advancing device 2 fails. By inserting a screwdriver of the corresponding shape into the safety groove 212 and rotating the screwdriver, the bolt 21 can be retracted from the adapter module 4, thereby allowing disassembly of the connection module.

FIG. 10 is a perspective view of an adapter module according to an embodiment of the present disclosure.

In an implementation of the present embodiment, as shown in FIG. 10, the adapter module 4 includes a multi-way connector 41 and a protective shell 42. The multi-way connector 41 is provided with an internal thread adapted to the bolt 21. The multi-way connector 41 is disposed in the protective shell 42. A shape of the protective shell 42 conforms to the adapter module 4. The multi-way connector 41 refers to a connector capable of connecting connecting pipes in multiple directions. Merely by way of example, when the adapter module 4 is of a cubic shape, the multi-way connector 41 may include connectors communicating with and arranged on six surfaces of the cube, capable of connecting connecting pipes in directions perpendicular to the six surfaces. The shape of the protective shell 42 may be a cubic frame with openings at locations where the connectors are provided.

The adapter module 4 may substitute for the function of the nut 22 when the threaded portion of the bolt 21 disengages from the nut 22, allowing the bolt 21 to continue advancing. By configuring the adapter module 4 to include the multi-way connector 41 and the protective shell 42, connection with other connection modules or structures is facilitated, and connected parts are protected.

An embodiment of the present disclosure further provides an article of modular assembled furniture including the connection module as described above.

### Working Principle

Referring to FIGS. 1-10, during operation of the connection module provided in an embodiment of the present disclosure, the connection module is first placed into a connecting pipe, aligning the second hole 32 with an opening on the connecting pipe. The limiting foot 72 of the position limiting device 7 is inserted into the limiting hole 34. When the limiting foot 72 passes through the rubber ring 8 in the rubber ring groove 35, the rubber ring 8 engages with the limiting foot 72 in an interference fit, firmly securing the position limiting device 7, thereby fixing the position limiting device 7 to the housing 3. At this time, the limiting part 71 of the position limiting device 7 protrudes above the connection module, precisely engaging with the opening of the connecting pipe, thereby fixing the connection module to the connecting pipe. Simultaneously, the adjustment opening 711 of the position limiting device 7 faces the input end of the input member 11.

Then, a suitable screwdriver is placed in the positioning groove 111 at the adjustment opening 711. Rotating the screwdriver causes the driving bevel gear to rotate horizontally, thereby driving the driven bevel gear to rotate vertically. The driven bevel gear is radially fixed and axially slidably connected to the bolt 21, so vertical rotation of the driven bevel gear drives rotation of the bolt 21. The nut 22 is limitedly disposed in the nut groove 33 and does not rotate. Consequently, the bolt 21 and the nut 22 cooperate with each other, causing the bolt 21 to advance toward the adapter module 4. Since the circlip 5 is fixed on the bolt 21, the circlip 5 advances together with the bolt 21, causing the spring 6 to be compressed under force. When the threaded portion of the bolt 21 disengages from the nut 22, the spring 6 rebounds, thereby driving the bolt 21 and the adapter module 4 connected to the bolt 21 to move toward the output member 12, and keeping the threaded portion of the bolt 21 in contact with a thread of the nut 22 to facilitate disassembly. At this time, the adapter module 4 allows the bolt 21 to continue advancing. The threaded portion of the bolt 21 tends to move away from the nut 22, while the smooth portion of the bolt 21 passes through the nut 22. The spring 6 rebounds, driving the bolt 21 and the adapter module 4 connected to the bolt 21 to move toward the output member 12, causing the adapter module 4 to fit more tightly against one end of the connecting pipe.

During advancement of the bolt 21, the flange 24 advances with the bolt 21 until abutting against the limiting protrusion 38, thereby limiting the advancement distance of the bolt 21. This prevents the connector 23 of the bolt 21 from disengaging from the connecting portion 121 of the output member 12, which may cause failure of the advancing device 2.

When the advancing device 2 fails, a suitable screwdriver is placed in the safety groove 212 of the bolt 21. Rotating the screwdriver drives rotation of the bolt 21, causing the bolt 21 to retract from the adapter module 4, thereby disassembling the connection module.

In summary, beneficial effects of the embodiments of the present disclosure include, but are not limited to:
1. By providing two bevel gears before the advancing device, horizontal rotational motion is converted into vertical rotational motion, thereby causing the bolt to perform spiral motion along the axis in the horizontal direction. Tightening can be achieved without rotating the entire connecting pipe. Compared with existing technologies that require rotating the entire connecting pipe along its axis to achieve connection and fixation, embodiments of the present disclosure can make the installation process time-saving and labor-saving, and can be applied to large-sized, heavy connecting pipes and structurally complex brackets.
2. By providing the circlip groove, disposing the circlip in the circlip groove, and providing the spring between the nut and the circlip, when the bolt advances spirally, the circlip fixed on the bolt advances together with the bolt and compresses the spring. When the threaded portion of the bolt disengages from the nut, the adapter module allows the bolt to continue advancing. The smooth portion of the bolt passes through the nut, and the spring rebounds, driving the bolt and the adapter module connected to the bolt to move toward the output member. On one hand, this configuration keeps the threaded portion of the bolt in contact with the thread of the nut to facilitate disassembly. On the other hand, this causes the adapter module to fit more tightly with the connection module. When applied in assembled furniture, the assembled furniture becomes flatter and more aesthetically pleasing, avoiding gaps that may trap hair or threads, thereby preventing harm to human and pet hair and damage to textiles.

The above are merely preferred implementations of the present disclosure. The scope of protection of the present disclosure is not limited to the above embodiments. Any technical solution within the concept of the present disclosure falls within the scope of protection of the present disclosure. It should be pointed out that for those of ordinary skill in the art, several improvements and modifications made without departing from the principles of the embodiments of the present disclosure should also be considered as within the scope of protection of the present disclosure.

Meanwhile, the present disclosure uses specific words to describe the embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

Similarly, it should be noted that to simplify the expression disclosed in the present disclosure and thereby help understand one or more inventive embodiments, in the foregoing description of the embodiments of the present disclosure, various features are sometimes grouped into one embodiment, drawing, or description thereof. However, this disclosure method does not mean that the subject matter of the present disclosure requires more features than those mentioned in the claims. Rather, claimed subject matter may lie in less than all features of a single foregoing disclosed embodiment.

For each patent, patent application, patent application publication, and other material, such as articles, books, specifications, publications, documents, etc., cited in the present disclosure, the entire content thereof is hereby incorporated by reference into the present disclosure. Application history documents inconsistent with or conflicting with the content of the present disclosure are excluded, and documents (currently or subsequently attached to the present disclosure) that limit the broadest scope of the claims of the present disclosure are also excluded. It should be noted that if descriptions, definitions, and/or use of terms in the attached materials of the present disclosure are inconsistent with or conflict with those in the present disclosure, the descriptions, definitions, and/or use of terms in the present disclosure prevail.

Finally, it should be understood that the embodiments described in the present disclosure are only used to illustrate the principles of the embodiments of the present disclosure. Other variations may also fall within the scope of the present disclosure. Therefore, as an example and not by way of limitation, alternative configurations of embodiments of the present disclosure may be considered to be consistent with the teachings of the present disclosure. Accordingly, embodiments of the present disclosure are not limited to the embodiments explicitly introduced and described in the present disclosure.

What is claimed is:

1. A connection module, comprising: a housing, a direction-changing device, an advancing device, and an adapter module; wherein
the housing is provided with a first hole and a second hole, the first hole is perpendicular to and communicates with the second hole, and a nut groove is provided near an opening of the first hole;
the direction-changing device includes an input member and an output member, the input member and the output member are respectively disposed in the second hole and the first hole, the input member is connected to the output member, and rotation of the input member in a horizontal direction drives the output member to rotate in a vertical direction;
the advancing device is disposed in the first hole, the advancing device includes a bolt and a nut, the nut is disposed in the nut groove, the bolt includes a threaded portion and a smooth portion, the threaded portion is threadedly connected to the nut, the smooth portion is radially fixed and axially slidably connected to the output member, the smooth portion is provided with a circlip groove, a circlip is disposed in the circlip groove, a spring is disposed between the circlip and the nut, and the spring is disposed on the bolt;
the adapter module is disposed at an exterior of the housing and includes a thread matching the bolt, and the adapter module is threadedly connected to the bolt after the bolt is advanced;
an end face of the threaded portion of the bolt is provided with a safety groove; and
the connection module further comprises a position limiting device mounted on the housing, the position limiting device includes a limiting part and a limiting foot, wherein the limiting part is connected to the limiting foot, the limiting part is provided with an adjustment opening, and the adjustment opening faces an input end of the input member.

2. The connection module according to claim 1, wherein
the input member is a driving bevel gear, and an input end of the driving bevel gear is provided with a positioning groove;
the output member is a driven bevel gear, an output end of the driven bevel gear is provided with a connecting portion, and the connecting portion is connected to one end of the smooth portion of the bolt; and
the driven bevel gear meshes with the driving bevel gear.

3. The connection module according to claim 2, wherein the one end of the smooth portion of the bolt is provided with a connector, and the connector is connected to the connecting portion.

4. The connection module according to claim 1, wherein the housing is further provided with a limiting hole, the limiting hole is configured to receive the limiting foot, a rubber ring groove is provided in the limiting hole, and a rubber ring is disposed in the rubber ring groove.

5. The connection module according to claim 1, wherein the housing includes a first shell and a second shell that are assembled together, and a cross-section of the housing is of an elliptical shape.

6. The connection module according to claim 1, wherein one end of the smooth portion of the bolt is provided with a flange, a limiting protrusion is provided in the first hole near the output member, and the limiting protrusion is configured to abut against the flange of the bolt.

7. The connection module according to claim 1, wherein the safety groove is a hexagonal blind hole or a square blind hole.

8. The connection module according to claim 1, wherein the adapter module includes a multi-way connector and a protective shell, the multi-way connector is provided with an internal thread adapted to the bolt, the multi-way connector is disposed in the protective shell, and a shape of the protective shell conforms to the adapter module.

9. An article of modular assembled furniture, comprising the connection module according to claim 1.
